(19) United States
(12) Patent Application Publication
(10) Pub. No.: US 2012/0013138 A1
(43) Pub. Date: Jan. 19, 2012

(54) GRIPPER SYSTEM FOR TRAY SEALING MACHINE

(75) Inventor: Lars Ickert, Kempten (DE)

(73) Assignee: MULTIVAC SEPP HAGGENMUELLER GMBH & CO. KG, Wolfertschwenden (DE)

(21) Appl. No.: 13/183,798

(22) Filed: Jul. 15, 2011

(30) Foreign Application Priority Data
Jul. 15, 2010 (DE) 102010027211.6

(51) Int. Cl. B66C 1/44

(52) U.S. Cl. 294/24

(57) ABSTRACT

A gripper system (4) for a tray sealing machine (1) for conveying trays (9) comprises gripper arms and a lifting device (100) for lifting the trays (9). The lifting device has a mechanism comprising a support element (10) for supporting an edge (12) of a tray (9), and the lifting device is configured to convert a closing motion (S) of the gripper arms (5, 6) towards each other into a lifting motion (H) of the support element (10).

### CROSS-REFERENCE TO RELATED APPLICATIONS

This application claims foreign priority benefits under 35 U.S.C. §119(a)-(d) to German patent application number DE 102010027211.6, filed Jul. 15, 2010, which is incorporated by reference in its entirety.

### TECHNICAL FIELD

This present disclosure relates to a gripper system for a tray sealing machine.

### BACKGROUND

In tray sealing machines, the trays are conveyed by an infeed conveyor to a sealing station. In single-track tray sealers, the transfer of the trays from the infeed conveyor into the sealing station is commonly performed by a gripper system. Said system comprises two gripper arms laterally engaging the trays provided on the infeed conveyor. During this process, it is possible that the infeed conveyor is at standstill or continues its operation. In the case of a continuing operation, the gripper arms synchronize their movement in the conveyance direction with the movement of the trays. After the gripper arms have come to bear against the trays, the movement in the direction of the sealing station is carried out. This transfer movement of the gripper arms is performed independently of the transport speed of the infeed conveyor. During this movement, friction occurs between the bottom of the tray and the conveyor belt of the infeed conveyor.

When oily and greasy products are handled, the conveyor belt partly loses its friction, and the trays are displaced from their predetermined position, which is necessary for engagement by the gripper arms, by slipping during their movement on the conveyor belt of the infeed conveyor. In order to solve this problem, conveyor belts with very high friction are used. As a consequence of dissimilar soiling, irregularities of the friction coefficient between the conveyor belt and the bottom of the trays occur. If the friction is too high, this has an adverse effect on the transfer of the trays by the gripper arms into the sealing station, since it leads to the strong friction at the bottom of the tray, and the tray tends to tilt. In particular with high trays this problem is precarious. If the product is in a liquid state, it may occur that parts of the products are spilled or slop over on the conveyor belt or in the sealing station. This may cause machine downtimes for cleaning purposes, and leads to an elevated rejection rate of underweight packages.

In order to guarantee a high production performance of trays to be packed, the gripper arms and the conveyor belt should not carry out a synchronized movement with respect to each other over the entire course of movement, while the trays are still on the conveyor belt of the infeed conveyor and are being transferred by the gripper arms into the sealing station, so as to be independent of the friction.

After the gripper arms have come into engagement with the trays, the conveyor belt has to take over the next trays fed in by a supply system and has to bring them into a predetermined spacing to each other. This leads to a motion profile that cannot be brought into conformity with the movement of the gripper arms.

### SUMMARY

It is an object of the present disclosure to provide a gripper system for a tray sealing machine and a method for operating a tray sealing machine capable of eliminating the drawbacks described hereinbefore.

The gripper system for a tray sealing machine for the transport of trays according to the present disclosure comprises at least two gripper arms with a vertical conveyor or (used as a synonym thereto in the following) a lifting device for lifting trays. The lifting device is configured to transform a closing motion of the gripper arms with respect to each other into a lifting motion of a support element. The lifting of the trays ensures that there will be no contact between the bottom of the tray and the infeed conveyor and that, consequently, the movements of the gripper system can be carried out without friction and independently from the movement of the infeed conveyor. Due to the fact that the lifting device lifts the trays relative to the gripper arm, the gripper arm itself does not have to be lifted any more so that its movement is faster and easier.

The movement of the lifting device for lifting the trays can be executed towards the end of the closing motion of the gripper arms with respect to each other, as soon as the support element comes into contact with the tray or the edge of the tray, respectively. At this stage of the motion, the gripper arms execute a closing motion approximately parallel to the infeed conveyor. This closing motion is transformed, via the mechanism of the support element and its engagement with a lower side of the tray edge, into a motion that effects the lifting of the tray.

The lifting device which is mounted on at least two gripper arms preferably comprises one or a plurality of leaf springs. Due to the spring constant of the leaf spring, in spite of a uniform closing motion of the gripper arms no shock is executed on the tray at the moment of contact of the support element with the tray, but the leaf spring is tensioned, and thus the lifting action is carried out smoothly. This prevents spilling of, e.g., liquid products from the tray while at the same time a high conveying performance is maintained.

A pivot axis of the lifting mechanism, disposed in parallel to the infeed conveyor, enables that by means of the leaf spring the support element, at one end of the leaf spring, or the leaf spring itself is pivotable about the pivot axis and is capable of lifting the tray up to 10 mm, which was not possible with the solution heretofore known.

The pivot axis can be configured as a hinge that is attached to the gripper arm by one side whereas the leaf spring is connected to the other side. The pivot axis can also be formed by the leaf spring itself if the leaf spring is directly attached to the gripper arm and is configured pivotably, starting from the point of attachment, due to its own bending capacity.

Preferably, the drive of the closing motion is a servo-controlled drive. Thus, the motion profile of the closure arms and, in dependence thereupon, the lifting motion of the tray can precisely be controlled so that, in spite of high accelerations and speeds, the trays can be moved smoothly and securely.

The lifting device with the support element receives the tray preferably at the lower edge of the rim of the tray in an positive fit or in a force fit (non-positive fit). This also secures the tray to the gripper system during the transport movement towards a work station or out of a work station.

The support element is preferably configured as a ledge which is attached at its freely movable end to one or the plurality of leaf springs and can be exchangeable in order to be able to adapt it to the geometry of the rim of the tray in case of a positive fit. It is also conceivable that the leaf spring itself is configured as a support element.

A method according to the present disclosure of operating a tray sealing machine including a gripper system for transporting trays and an infeed conveyor is also provided. The method comprises closing gripper arms of the gripper system toward each other for gripping a tray such that a lifting device mounted to a gripper arm converts the closing motion of the gripper arms, by which the tray is seized, into a lifting motion of the tray with respect to the infeed conveyor in order to avoid a contact of the tray with the infeed conveyor at the end of the motion.

The conversion of the closing motion into the lifting motion is preferably effected towards the end of the closing motion of the gripper arms so as to be able to move the gripper arms with maximum velocity until the moment of conversion so as not to restrict the performance of the tray sealing machine.

At the end of the conveying movement of the trays to a work station, the gripper arms perform an opening movement, thus lowering the trays. This movement is substantially vertically downward.

At the moment when the support element comes into contact with the edge of the tray, the closing motion of the gripper arms is continued, said motion being an approximately horizontal motion relative to the infeed conveyor. The tray containing products has a weight force that must be overcome by the mechanism on the gripper arm in order to lift the tray. The closing motion of the gripper arms induces tensioning of the leaf spring. Since the position of one end of the leaf spring at the edge of the tray does not change, and the other end of the leaf spring on the gripper arm continues approaching the tray, this results in bending and, consequently, tensioning of the leaf spring. The tensioning of the leaf spring generated by the closing force is continued until the tensioning force of the leaf spring equals the weight force of the tray or trays. The ongoing closing force not only causes a further tensioning of the leaf spring but also effects the lifting of the trays. Due to the gradually increasing and not suddenly occurring tensioning of the leaf spring, the tray is smoothly lifted so that no losses of products from the tray occur.

In the following, an advantageous embodiment of the present disclosure will be explained in more detail on the basis of the below drawings.

### BRIEF DESCRIPTION OF THE DRAWINGS

FIG. 1 shows a schematic view of a tray sealing machine;

FIG. 2 shows a view of a gripper system in an opened position;

FIG. 3 shows a view of a gripper system in a closed position;

FIG. 4a shows a view along a transport direction of a gripper system according to the present disclosure in an opened position;

FIG. 4b shows a view along a transport direction of a gripper system according to the present disclosure in a closing motion and in contact with a tray;

FIG. 4c shows a view along a transport direction of a gripper system according to the present disclosure in a closed position and with a lifted tray; and

FIG. 5 shows a top view of a gripper system according to the present disclosure in an opened position.

### DETAILED DESCRIPTION

Identical components are designated by identical reference numerals in all the figures.

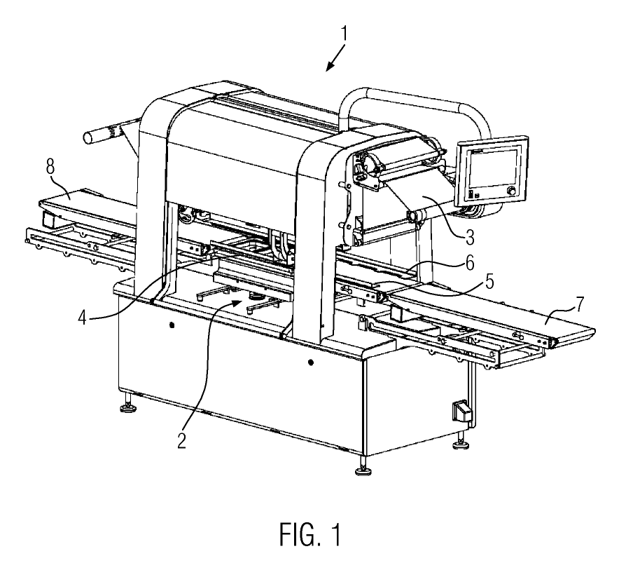

FIG. 1 shows a tray sealing machine 1 comprising a work station 2 which seals trays (not represented) with a lid film 3, and a gripper system 4 having a first gripper arm 5 and a second gripper arm 6, and moving the trays from an infeed conveyor 7 into the work station 2. After the sealing process in the work station 2, the sealed trays are conveyed out of the work station 2 by means of the gripper system 4 and placed on a discharge belt and supplied to the next process step.

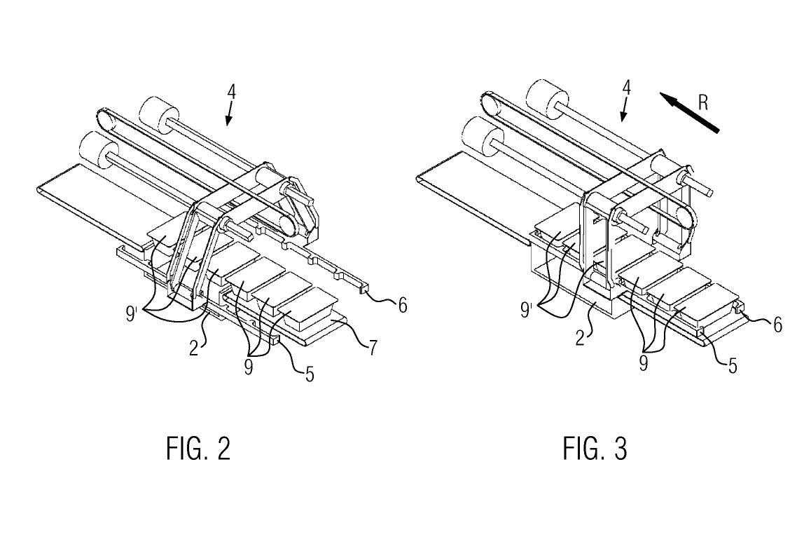

In FIG. 2, the gripper system 4 is represented in an opened position. Three trays 9 are placed on the infeed conveyor belt 7, and in the work station 2 there are also three trays 9′. The gripper arms 5, 6 are in an opened position.

In FIG. 3, the gripper system 4 is represented in a closed position. The gripper arms 5, 6 have been moved towards each other and to the trays 9, and are in contact with the trays 9. Subsequently, the gripper system 4 transfers the trays 9 from infeed conveyor 7 in a transport direction R into the work station 2 and simultaneously also transfers the three trays 9′ from the work station 2 to the discharge belt 8.

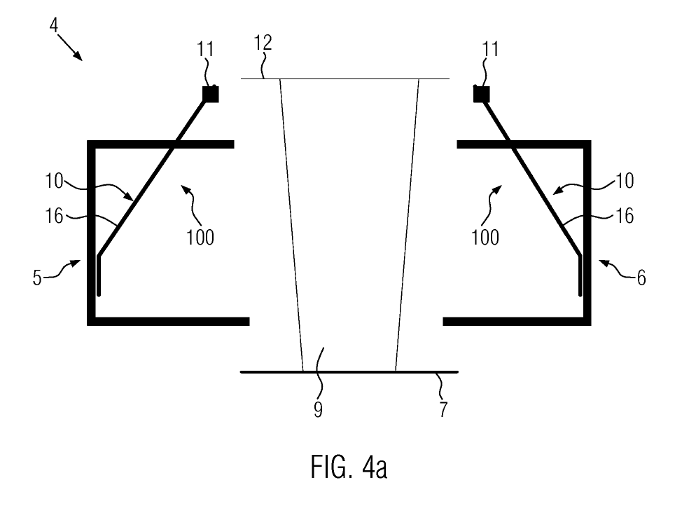

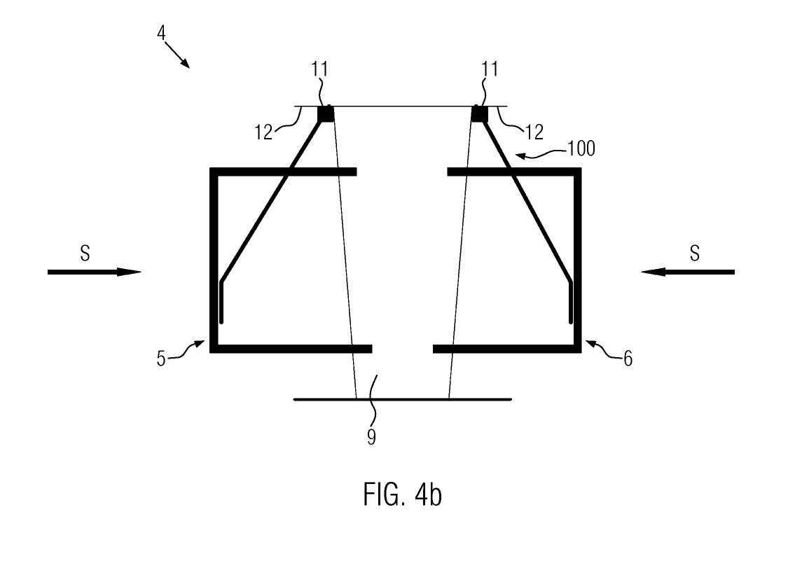

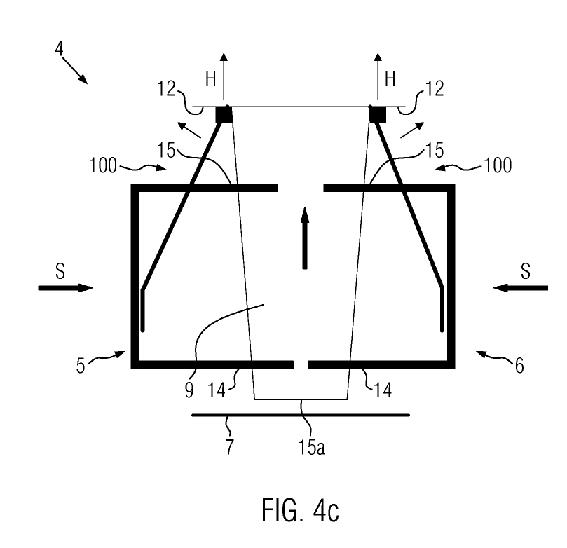

A gripper system 4 according to the present disclosure is shown in FIG. 4a. Each of the two grippers 5, 6 comprises a lifting device 100 mounted to the respective gripper arm 5,6 on the side facing the trays 9. Each of the lifting devices 100 comprises a support element 10 having a ledge or rail 11. The support element 10 is fixedly connected to the gripper arm 5,6, and the ledge 11 is mounted to the respective gripper arm 5,6 by means of one or a plurality of leaf springs 16. The ledge 11 and the leaf springs 16 may also be integrally formed, e.g. in a punched configuration made of spring steel. The tray 9 has a circumferential tray edge 12. The lifting device 100 comprises the support element 10, the ledge 11 and the leaf springs 16.

In FIG. 4b, the gripper arms 5, 6 are represented in their closing motion S directed towards each other and towards the tray 9. The ledge 11 comes into contact with the tray edge 12 while the closing motion S is being continued.

In FIG. 4c, the closing motion S is finished and the gripper arms 5, 6 are in contact with the tray 9 in its lower portion 14 and/or its upper portion 15, the engagement being a positive fit and/or a non-positive fit engagement. For example, the gripper arms 5, 6 may have a shape or configuration that corresponds with the shape of the tray 9 such that the gripper arms 5, 6 mate with the tray 9 when the gripper arms 5, 6 are in the closed position, shown in FIG. 4c, to achieve a positive fit. As another example, the gripper arms 5,6 may be forced into engagement with the tray 9 when the gripper arms 5, 6 are in the closed position to achieve a force fit or non-positive fit. Furthermore, the support element 10 lifts the tray edge 12 or the tray 9, respectively, approximately in a vertical direction thereby generating a space between the bottom 15a and the infeed conveyor 7. The movements of the gripper system 4 in the transport direction R and the movement of the infeed conveyor 7 thus can be separately controlled, without any negative mutual effects occurring.

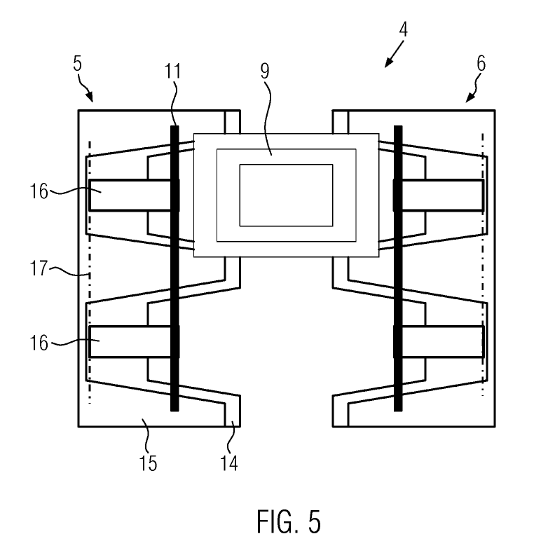

FIG. 5 shows a top view of the gripper system 4 according to the present disclosure, with a ledge 11 and two leaf springs 16 for simultaneously receiving two trays 9. The ledge 11 may also be separated into two parts per individual support element 10, or be integrally punched from spring steel an attached to the gripper arms 5,6 by welding. A variant in which the support element 10 comprises a hinge in order to enable the lateral deflection is also conceivable, the resilient effect being realized by a spring.

The lateral deflection of the leaf springs 16 is obtained via the pivot axis 17 which, according to a variant, may be configured as a hinge.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A gripper system for a tray sealing machine for conveying trays, the gripper system comprising:
at least two gripper arms; and
a lifting device on at least one of the gripper arms for lifting a tray relative to the gripper arms, the lifting device having a support element for supporting an edge of the tray and being configured to convert a closing motion of the gripper arms towards each other into a lifting motion of the support element.

2. The gripper system according to claim 1 wherein the lifting device comprises one or a plurality of leaf springs.

3. The gripper system according to claim 2 wherein the tray sealing machine includes an infeed conveyor for conveying trays toward the gripper system, and wherein each leaf spring is pivotable about a pivot axis positioned parallel to the infeed conveyor.

4. The gripper system according to claim 1 further comprising a servo motor drive associated with the gripper arms, and wherein the closing motion of the gripper arms is driven by the servo motor drive.

5. The gripper system according to claim 1 wherein the gripper arms are configured for receiving the trays by a positive fit and/or a force fit.

6. The gripper system according to claim 1 wherein the support element is adapted to receive the tray at the edge of the tray.

7. The gripper system according to claim 1 wherein the support element has a ledge that receives the tray at the edge of the tray, and at least one leaf spring that connects the ledge to the at least one gripper arm.

8. The gripper system according to claim 1 wherein the lifting device is mounted on a first one of the gripper arms, and wherein the gripper system further includes an additional lifting device mounted on a second one of the gripper arms, the additional lifting device including an additional support element for supporting an additional edge of the tray, and being configured to cause a lifting motion of the additional support element in response to the closing motion of the gripper arms.

9. A method of operating a tray sealing machine comprising a gripper system for conveying trays and an infeed conveyor for conveying the trays toward the gripper system, the gripper system having at least two gripper arms, the method comprising:
closing the gripper arms toward each other for gripping a tray such that a lifting device on at least one gripper arm converts the closing motion of the gripper arms into a lifting motion of the tray relative to the infeed conveyor.

10. The method according to claim 9 wherein the lifting motion of the tray is executed towards the end of the closing motion of the gripper arms.

11. The method according to claim 9 wherein the lifting device is configured to lower the tray when the gripper arms perform an opening motion.

12. The method according to claim 9 wherein a force for lifting the tray by the lifting device is generated by a closing force of the gripper arms.

13. A gripper system for a tray sealing machine for conveying trays, the gripper system comprising:
first and second gripper arms, the first gripper arm being movable toward the second gripper arm to grip a tray; and
a lifting device associated with at least one of the gripper arms for lifting a tray relative to the gripper arms, the lifting device including a support element for supporting an edge of the tray;
wherein movement of the first gripper arm toward the second gripper arm causes the lifting device to effect a lifting motion of the support element to thereby lift the tray.

14. The gripper system according to claim 13 wherein the lifting device is mounted on the first gripper arm, and wherein the gripper system further includes an additional lifting device mounted on the second gripper arm, the additional lifting device including an additional support element for supporting an additional edge of the tray, and being configured to cause a lifting motion of the additional support element in response to movement of the first gripper arm toward the second gripper arm.

15. The gripper system according to claim 14 wherein each lifting device comprises one or more leaf springs.

16. The gripper system according to claim 15 wherein the tray sealing machine includes an infeed conveyor for conveying trays toward the gripper system, and wherein each leaf spring is pivotable about a pivot axis positioned parallel to the infeed conveyor.

17. The gripper system according to claim 14 wherein the support element is pivotable with respect to the first gripper arm, and the additional support element is pivotable with respect to the second gripper arm.

18. The gripper system according to claim 13 wherein the gripper arms are moveable toward and away from each other.
